(19) United States
(12) Patent Application Publication
(10) Pub. No.: US 2024/0183388 A1
(43) Pub. Date: Jun. 6, 2024

(54) ROLLING BEARING WITH PROTRUDING NOSE AND GEAR

(71) Applicant: AKTIEBOLAGET SKF, GOTEBORG (SE)

(72) Inventor: Bruno Capoldi, Charentenay (FR)

(21) Appl. No.: 18/515,765

(22) Filed: Nov. 21, 2023

(30) Foreign Application Priority Data
Dec. 5, 2022 (DE) 102022213073.1

(51) Int. Cl. F16C 19/54

(52) U.S. Cl. CPC F16C 19/545

(57) ABSTRACT

A rolling bearing includes a first ring, a second ring, a gear provided on the first ring, at least one row of axial rolling elements arranged between radial raceways provided on the first and second rings, and at least one row of radial rolling elements arranged between axial raceways provided on the two rings. The second ring has a protruding nose which is engaged into an annular groove of the first ring, the nose being provided with the axial raceway and with the radial raceway of the second ring.

### CROSS-REFERENCE

This application claims priority to German patent application no. 102022213073.1 filed on Dec. 5, 2022, the entire contents of which are fully incorporated herein by reference.

### BACKGROUND OF THE INVENTION

The present invention relates to rolling bearings, more particularly to large-diameter rolling bearings that can accommodate axial and radial loads and having an inner ring and an outer ring arranged concentrically about an axis of rotation running in an axial direction.

Such large-diameter rolling bearings may be used, for example, in a tunnel boring machine, in a mining extraction machine or in a wind turbine. One such type of large-diameter rolling bearing comprises two concentric inner and outer rings, at least two rows of axial rollers, and one row of radial rollers. Such a bearing may include an inner ring provided with an internal gear and with a protruding nose extending radially outwardly and engaging into a groove of the outer ring.

More specifically, the row of radial rollers is arranged radially between the nose of the inner ring and the groove of the outer ring and the rows of axial rollers are arranged axially between the nose of the inner ring and the groove of the outer ring, the rows of axial rollers being disposed on each side of the nose. The axial length of the axial rollers of one row is generally larger or longer than the axial rollers of the other row. The row with the longer axial rollers is the main row of axial rollers.

Generally, the inner ring of the rolling bearing is also provided with axial through-holes in order to assemble the inner ring to the structure of the associated machine. With such a design, there is no capability of increasing the roller size of the main row of axial rollers without changing the bearing diameter.

### SUMMARY OF THE INVENTION

One aim of the present invention is to overcome the drawback as discussed above. As such, the present invention relates to a rolling bearing comprising a first ring and a second ring capable of rotating concentrically relative to one another, a gear provided on one of the rings, at least one row of axial rolling elements arranged between radial raceways provided on the rings, and at least one row of radial rolling elements arranged between axial raceways provided on the rings.

As used herein, the term “axial rolling elements” is understood to mean rolling elements adapted to accommodate axial loads whereas the term “radial rolling elements” is understood to mean rolling elements adapted to accommodate radial loads.

The second ring includes a protruding or projecting annular nose engaged into, i.e., disposed within, an annular groove of the first ring, the annular nose being provided with both the axial raceway and the radial raceway of the second ring. In general, the first ring is provided with the gear.

Due to the present invention, the bearing capacity can be increased by increasing the size of the axial rollers without changing the bearing diameter and the location of the bolts used to assemble the bearing to the structure of the associated machine.

Preferably at least the first ring is formed as a split ring and includes a first ring part and a second ring part, the two ring parts being axially stacked or abutting and the gear being provided on one of the first and second ring parts. The first and second ring parts of the first ring may be provided with a plurality of aligned axial through-holes, the axial through-holes being located radially between the row of radial rolling elements and the gear.

The second ring is provided with frontal faces or end faces axially delimiting the ring, a plurality of threaded blind-holes may extend axially from one of these frontal faces, the other frontal face may delimit the radial raceway of the protruding nose. In one embodiment, the row of axial rolling elements extends partly or partially beyond the center of the threaded blind-holes on the side opposite to the row of radial rolling elements.

In one embodiment, the rolling bearing comprises at least two rows of axial rolling elements each arranged between radial raceways provided on the two rings, the two rows of axial rolling elements being disposed axially on each side of the protruding nose of the second ring.

In one embodiment, the first ring is the inner ring and the second ring is the outer ring. Alternatively, the first ring is the outer ring and the second ring is the inner ring.

### BRIEF DESCRIPTION OF THE SEVERAL VIEWS OF THE DRAWINGS

The present invention and its advantages will be better understood by studying the detailed description of specific embodiments given by way of non-limiting examples and illustrated by the appended drawings on which:

FIG. 1 is a partial cross-section of a rolling bearing according to an example of the invention; and

FIG. 2 is a partial cross-section of a rolling bearing according to another example of the invention.

### DETAILED DESCRIPTION OF THE INVENTION

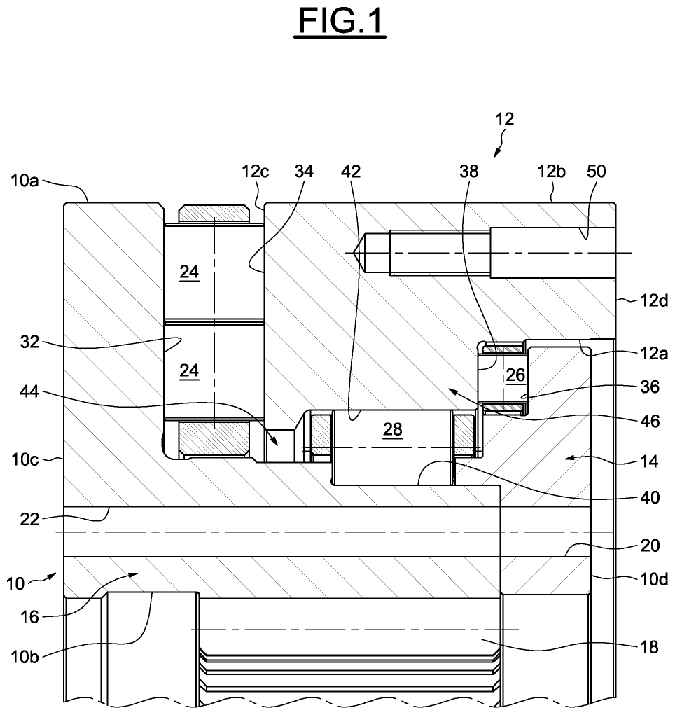

The rolling bearing as illustrated in FIG. 1 is a large-diameter rolling bearing comprising a first ring 10 and a second ring 12. In the illustrated example, the first ring 10 is the inner ring whereas the second ring 12 is the outer ring. In this example, the inner ring 10 is a rotative or rotatable ring and the outer ring 12 is a fixed or non-rotative/non-rotatable ring. The rolling bearing may be used, for example, in a tunnel boring machine, a wind turbine, a large offshore crane or any other applications using a large diameter rolling bearing.

The inner and outer rings 10, 12 are concentric and extend axially along the bearing rotation axis (not shown) which runs in an axial direction. In this illustrated example, the rings 10, 12 are of the solid type.

As described in further detail below, the inner ring 10 is provided with a gear 18. Preferably, the inner ring 10 is formed as a split ring and includes a first ring part 14 and a second ring part 16 stacked relative to each other in the axial direction, such that the two ring parts 14, 16 are axially abutting. The first ring part 14 forms a retaining ring whereas the second ring part 16 forms a supporting ring.

Each of the first and second ring parts 14, 16 of the first, inner ring 10 is provided with a plurality of aligned through-holes 20, 22, respectively, in order to be joined together by fitting bolts. The through-holes 20, 22 of each of the first and second ring parts 14, 16 are spaced apart in the circumferential direction.

In the illustrated example, the rolling bearing comprises three rows of axial rollers 24, 26 arranged between the inner and outer rings 10, 12 in order to form an axial thrust and a row of radial rollers 28 which are arranged between the rings 10, 12 to form a radial thrust.

The rollers 24, 26, 28 of each row are preferably identical to one another; that is, all of the rollers 24 are identical to each other, all of the rollers 26 are identical to each other and all of the rollers 28 are identical to each other. The axis of rotation of each roller 28 is parallel to the axis of the bearing and perpendicular to the axes of the rollers 24, 26. In the illustrated example, there are two rows of superimposed rollers 24. Alternatively, the two rows of rollers 24 may be replaced by a single row of rollers 24. The rollers 24 form the main row of axial rollers of the rolling bearing.

The axial rollers 24 are interposed or disposed axially between two annular radial raceways 32, 34 formed on the inner and outer rings 10, 12, respectively. The raceways 32, 34 face each other in the axial direction and the rolling surface of each axial roller 24 is in axial contact with each of the two raceways 32, 34.

The axial rollers 26 are interposed or disposed axially between two annular radial raceways 36, 38 formed on the inner and outer rings 10, 12, respectively. The two raceways 36, 38 axially face each other and the rolling surface of each axial roller 26 is in axial contact with each of the two raceways 36, 38. The rows of axial rollers 24, 26 are spaced apart from each other in the axial direction.

The radial rollers 28 are interposed/disposed radially between two annular axial raceways 40, 42 formed on the inner and outer rings 10, 12, respectively. The two raceways 40, 42 face each other in the radial direction and the row of radial rollers 28 is radially offset inwardly with respect to the rows of axial rollers 24, 26. The rolling surface of each radial roller 28 is in radial contact with each of the two raceways 40, 42. Further, the row of radial rollers 28 is axially located between the rows of axial rollers 24, 26.

The inner ring 10 includes an annular groove 44 opening in a radial direction outwardly toward the outer ring 12 and an outer stepped cylindrical surface 10a from which the groove 44 is formed. As previously mentioned, the inner ring 10 is divided in the axial direction in two separate parts, the first ring part 14 and the second ring part 16. The first and second ring parts 14, 16 together delimit or define the groove 44. The radial raceway 36 is located on the first ring part 14 and the radial raceway 32 and the axial raceway 40 are both located on the second ring part 16.

The inner ring 10 also includes an inner cylindrical bore 10b which is radially opposite to the outer surface 10a. The inner ring 10 further includes two opposite first and second frontal faces 10c, 10d which axially delimit both the outer surface 10a and the bore 10b. The frontal faces 10c, 10d axially delimit the thickness of the inner ring 10. The frontal face 10d is located on the first ring part 14 and the frontal face 10d is located on the second ring part 16.

The outer ring 12 includes an annular protruding nose 46, in other words, an annular shoulder 46, engaging into and disposed at least partially within the annular groove 44 of the inner ring 10. In the depicted embodiments, the nose 46 extends or projects radially inwardly, specifically, the nose 46 protrudes radially from an inner stepped surface or bore 12a of the outer ring 12.

The outer ring 12 also includes an outer cylindrical surface 12b which is radially opposite to the bore 12a. The outer ring 12 further includes two opposite first and second frontal faces or end faces 12c, 12d which axially delimit the outer surface 12b and the bore 12a. The frontal faces 12c, 12d also axially delimit the thickness of the outer ring 12. In the illustrated example, the outer ring 12 is made in one part, i.e., is of one-piece construction. Alternatively, the outer ring 12 may be formed as at least two or more separate parts secured or connected together. For example, the annular nose or shoulder 46 may be made separately from, and thereafter connected with, the main part of the outer ring 12.

The outer ring 12 is further provided with a plurality of threaded blind-holes 50 extending axially inwardly from the frontal face 12d. The threaded blind-holes 50 are configured to receive fitting bolts in order to assemble the outer ring 12 to the structure of the associated machine. The threaded blind-holes 50 are spaced apart in the circumferential direction. The axial rollers 24 extend partly or partially beyond the center of the threaded blind-holes 50 on the side opposite to the radial rollers 28. In other words, the axial rollers 24 extend partly beyond the center of the threaded blind-holes 50 on the side of the outer surface 12b of the outer ring 12.

The rows of axial rollers 24, 26 are arranged or disposed axially between the nose 46 of the outer ring 12 and the groove 44 of the inner ring 10. The rows of axial rollers 24, 26 are disposed on each axial side of the nose 46. The radial raceways 34, 38 are located or formed on the nose 46; that is, each radial raceway 34, 38 is formed on a separate axial end of the nose 46.

The frontal face 12c of the outer ring 12 delimits the radial raceway 34 of the nose 36, that is, the radial raceway 34 is formed on the frontal or end face 12c of the outer ring 12. The radial raceways 32, 36 of the inner ring 10 are located on or within the groove 44.

The row of radial rollers 28 is arranged or disposed radially between the nose 46 of the outer ring 12 and the groove 44 of the inner ring 10. The axial raceways 40, 42 are respectively located on the groove 44 and the nose 46. More specifically, an inner cylindrical surface or bore of the nose 46 delimits the axial raceway 42 and an axial bottom of the groove 44 delimits the axial raceway 40. The axial raceway 40 radially faces the inner cylindrical bore of the nose 46 onto which is formed the axial raceway 42.

The rolling bearing preferably also comprises cages (not referenced) for maintaining the axial rollers 24, 26 and the radial rollers 28 spaced apart in the circumferential direction.

As discussed above, the inner ring 10 is preferably provided with a gear 18, which is formed on a section of the inner ring 10. Specifically, in the depicted embodiments, the bore 10b of the inner ring 10 is provided with the gear 18. As such, the gear 18 is an internal gear. The gear 18 is provided with a plurality of successive teeth in the circumferential direction, that is, the teeth are spaced circumferentially apart. Further, the through-holes 20, 22 are located radially between the gear 18 and the radial rollers 28. In the illustrated example, the gear 18 is provided on the supporting ring part 16 of the inner ring 10.

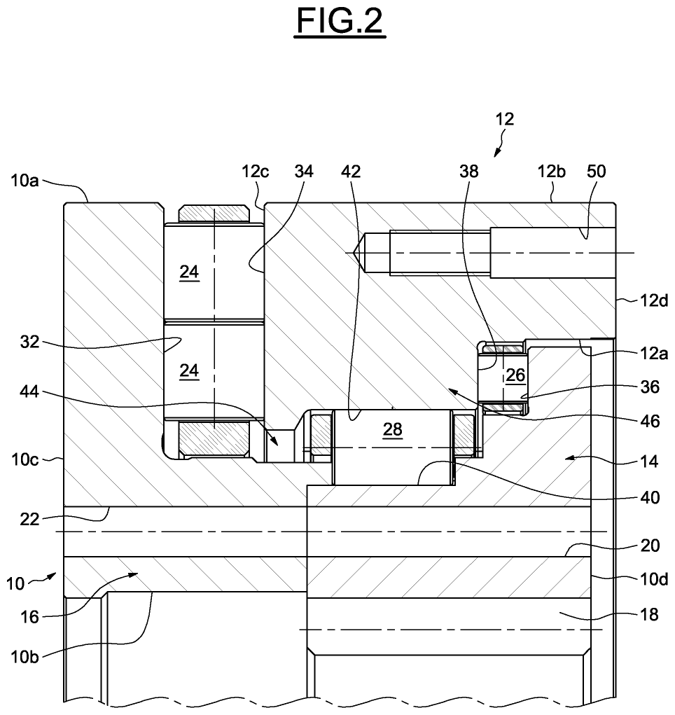

Referring to FIG. 2, in which identical parts are given identical references, a second exemplary embodiment of the rolling bearing differs from the first example in that the internal gear 18 is provided on the retaining ring part 14 of the inner ring 10. In this example, the axial raceway 40 is located on the retaining ring part 14.

Otherwise, as previously mentioned, in these illustrated examples, the first ring 10 of the rolling bearing is the inner ring whereas the second ring 12 is the outer ring.

Alternatively, a reversed arrangement may be provided in which the first ring 10 forms the outer ring and the second ring 12 forms the inner ring. In this case, the groove formed on the outer ring 10 opens radially inwardly and the nose of the inner ring 12 extends radially outwardly. In this case, the outer surface of the outer ring 10 is provided with the gear. In this alternative, the gear is an external gear.

In the described examples, the rolling bearing is provided with a rolling bearing comprising four rows of rolling elements. Alternatively, the rolling bearing may comprise only two rows of rolling elements or three or five or more rows of rolling elements. In the illustrated example, the rolling elements are rollers. The rolling bearing may comprise other types of rolling elements, for example balls, needles, etc.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A rolling bearing comprising:
a first ring having at least one radial raceway, at least one axial raceway, and an annular groove;
a second ring having a protruding nose engaged into the annular groove of the first ring and provided with at least one radial raceway and at least one axial raceway;
a gear provided on the first ring;
at least one row of axial rolling elements arranged between the radial raceways provided on the first and second rings; and
at least one row of radial rolling elements arranged between the axial raceways provided on the first and second rings.

2. The rolling bearing according to claim 1, wherein at least the first ring is formed as a split ring and includes a first ring part and a second ring part, the first and second ring parts being axially stacked and the gear being provided on one of the first and second ring parts.

3. The rolling bearing according to claim 2, wherein the first and second ring parts of the first ring are provided with a plurality of aligned axial through-holes, the axial through-holes being located radially between the at least one row of radial rolling elements and the gear.

4. The rolling bearing according to claim 1, wherein the second ring has two frontal faces axially delimiting the ring, a plurality of threaded blind-holes extending axially from one of the two frontal faces, the other one of the two frontal faces delimiting the at least one radial raceway of the protruding nose.

5. The rolling bearing according to claim 4, wherein the row of axial rolling elements extends partially beyond the center of the threaded blind-holes on a side opposite to the row of radial rolling elements.

6. The rolling bearing according to claim 1, wherein the at least one row of axial rolling elements includes at least two rows of axial rolling elements each arranged between radial raceways provided on the first and second rings, the at least two rows of axial rolling elements being disposed axially on each axial side of the protruding nose of the second ring.

7. The rolling bearing according to claim 1, wherein the first ring is an inner ring and the second ring is an outer ring.

8. The rolling bearing according to claim 1, wherein the first ring is an outer ring and the second ring is an inner ring.

9. A rolling bearing comprising:
a first ring having at least one radial raceway, at least one axial raceway, an annular groove and a gear formed on a section of the first ring;
a second ring having an annular nose projecting radially from a remainder of the second ring and disposed at least partially within the annular groove of the first ring, the annular nose having at least one radial raceway and at least one axial raceway;
at least one row of axial rolling elements disposed between the at least one radial raceway of the first ring and the at least one radial raceway of the second ring; and
at least one row of radial rolling elements disposed between the at least one axial raceway of the first ring and the at least one axial raceway of the second ring.

10. The rolling bearing according to claim 9, wherein at least the first ring is formed as a split ring and includes a first ring part and a second ring part, the first and second ring parts being axially abutting and the gear being formed on the first ring part or on the second ring part.

11. The rolling bearing according to claim 10, wherein the first ring part and the second ring part of the first ring are each provided with a plurality of aligned axial through-holes, the axial through-holes being located radially between the at least one row of radial rolling elements and the gear.

12. The rolling bearing according to claim 9, wherein the second ring has two end faces axially delimiting the second ring, a plurality of threaded blind-holes extending axially from one of the two end faces, the other one of the two end faces delimiting the at least one radial raceway on the annular nose.

13. The rolling bearing according to claim 12, wherein the row of axial rolling elements extends partially beyond the center of threaded blind-holes on a side opposite to the at least one row of radial rolling elements.

14. The rolling bearing according to claim 9, wherein the at least one row of axial rolling elements includes at least two rows of axial rolling elements, each row of axial rolling elements being disposed between two facing radial raceways provided on the first ring and on the second ring, the at least two rows of axial rolling elements being disposed axially on a separate one of two axial sides of the annular nose of the second ring.

15. The rolling bearing according to claim 9, wherein the first ring is an inner ring and the second ring is an outer ring.
